(19) United States
(12) Patent Application Publication
(10) Pub. No.: US 2025/0308208 A1
(43) Pub. Date: Oct. 2, 2025

(54) METHOD, INFORMATION PROCESSING DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Hikaru KURASAWA, Matsumoto-shi (JP)

(21) Appl. No.: 19/094,845

(22) Filed: Mar. 29, 2025

(30) Foreign Application Priority Data
Mar. 29, 2024 (JP) 2024-057175
Mar. 29, 2024 (JP) 2024-057192

(51) Int. Cl. G06V 10/764; G06V 10/44; G06V 10/74; G06V 10/771; G06V 10/82

(52) U.S. Cl. CPC G06V 10/764; G06V 10/44; G06V 10/761; G06V 10/771; G06V 10/82

(57) ABSTRACT

A method of generating descriptive information regarding class classification includes a step of inputting input data to a machine learning model again and acquiring a set of M×N first feature vectors corresponding to a size of the first feature maps from L first feature maps that are outputs of a specific layer, a step of generating, for each class group, a known feature vector including a set of the first feature vectors, a step of receiving a designation of a range in discrimination target data, a step of inputting the discrimination target data to the machine learning model and acquiring a set of M×N second feature vectors corresponding to the size of the second feature map from a second feature map that is an output of the specific layer, and a step of calculating a similarity between the designated range in the discrimination target data and at least one of the classes using the set of second feature vectors and the known feature vector group of at least one of the classes.

The present application is based on, and claims priority from JP Application Serial Number 2024-057175, filed Mar. 29, 2024, and 2024-057192, filed Mar. 29, 2024, the disclosures of which are hereby incorporated by reference herein in its entirety.

### BACKGROUND

### 1. Technical Field

The present disclosure relates to a method, an information processing device, and a non-transitory computer-readable storage medium storing a program.

### 2. Related Art

Yuki Ukai, three others, “Toward Prototypical Part Interpretable Similarity Learning With ProtoMetric”, IEEE Access, Jun. 19, 2023, [online], [Retrieved on Jan. 26, 2024], Internet URL: https://doi.org/10.1109/ACCESS.2023.3287638 discloses a technology related to a deep neural network (DNN) capable of interpreting an inference process.
In the technology described in Yuki Ukai, three others, “Toward Prototypical Part Interpretable Similarity Learning With ProtoMetric”, IEEE Access, Jun. 19, 2023, [online], [Retrieved on Jan. 26, 2024], Internet URL: https://doi.org/10.1109/ACCESS.2023.3287638, descriptive information indicating which feature of a prototype selected as representative data from training data is similar to a small region obtained by dividing input data and indicates a degree of similarity is generated in order to describe a result of class discrimination using the DNN. However, in the technology described in Yuki Ukai, three others, “Toward Prototypical Part Interpretable Similarity Learning With ProtoMetric”, IEEE Access, Jun. 19, 2023, [online], [Retrieved on Jan. 26, 2024], Internet URL: https://doi.org/10.1109/ACCESS.2023.3287638, the degree of similarity is calculated only when there is a small region similar to a feature of the prototype in the input data. There is a problem in that descriptive information cannot be generated for an arbitrary range designated by a user in an entire range of the input data.

### SUMMARY

The present disclosure can be realized in the following aspects.

According to a first aspect of the present disclosure, there is provided a method of generating descriptive information regarding a class classification of a machine learning model for classifying classes of input data. The machine learning model is a convolutional neural network including a plurality of residual blocks and including convolutional layers, and is generated by machine learning using a training dataset including a set of pairs of a plurality of pieces of input data and a prior label associated with the input data, the prior label indicating a class to which the input data belongs among a plurality of classes. The method includes (a) a step of inputting the input data belonging to one of the classes to the machine learning model again, and acquiring a set of M×N first feature vectors corresponding to a size of first feature maps and associated with one of the classes from L first feature maps that are outputs of a specific layer of the machine learning model, M and N being integers equal to or greater than 1, L being the number of channels, the first feature vector being obtained by vectorizing a feature amount included in L first feature maps along a channel direction, (b) a step of executing the step (a) using each of the plurality of pieces of input data belonging to one of the classes as an input, (c) a step of executing the step (b) for each of the plurality of classes to generate, for each class, a known feature vector group including a set of the first feature vectors associated with the classes, (d) a step of receiving a designation of a range serving as a similarity calculation target in discrimination target data different from the input data, the discrimination target data being discrimination target data input to the machine learning model, (e) a step of inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction, (f) a step of associating information indicating a position in the second feature map that is an output of the specific layer with each of the second feature vectors included in the set of second feature vectors acquired in the step (e), and (g) a step of calculating a similarity between the designated range in the discrimination target data and at least one of the classes using the set of second feature vectors acquired in the step (e) and the known feature vector group of at least one of the classes.

According to a second aspect of the present disclosure, there is provided an information processing device for generating descriptive information regarding a class classification of a machine learning model for classifying classes of input data. The machine learning model is a convolutional neural network including a plurality of residual blocks and including convolutional layers, and is generated by machine learning using a training dataset including a set of pairs of a plurality of pieces of input data and a prior label associated with the input data, the prior label indicating a class to which the input data belongs among a plurality of classes. The information processing device executes (a) processing for inputting the input data belonging to one of the classes to the machine learning model again, and acquiring a set of M×N first feature vectors corresponding to a size of first feature maps and associated with one of the classes from L first feature maps that are outputs of a specific layer of the machine learning model, M and N being integers equal to or greater than 1, L being the number of channels, the first feature vector being obtained by vectorizing a feature amount included in L first feature maps along a channel direction, (b) processing for executing the processing (a) using each of the plurality of pieces of input data belonging to one of the classes as an input, (c) processing for executing the processing (b) for each of the plurality of classes to generate, for each class, a known feature vector group including a set of the first feature vectors associated with the classes, (d) processing for receiving a designation of a range serving as a similarity calculation target in discrimination target data different from the input data, the discrimination target data being discrimination target data input to the machine learning model, (e) processing for inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction, (f) processing for associating information indicating a position in the second feature map that is an output of the specific layer with each of the second feature vectors included in the set of second feature vectors acquired in processing (e), and (g) processing for calculating a similarity between the designated range in the discrimination target data and at least one of the classes using the set of second feature vectors acquired in the processing (e) and the known feature vector group of at least one of the classes.

According to a third aspect of the present disclosure, there is provided a non-transitory computer-readable storage medium storing a program for causing a computer to execute processing for generating descriptive information regarding a class classification of a machine learning model for classifying classes of input data. The machine learning model is a convolutional neural network including a plurality of residual blocks and including convolutional layers, and is generated by machine learning using a training dataset including a set of pairs of a plurality of pieces of input data and a prior label associated with the input data, the prior label indicating a class to which the input data belongs among a plurality of classes. The program causes the computer to execute (a) processing for inputting the input data belonging to one of the classes to the machine learning model again, and acquiring a set of M×N first feature vectors corresponding to a size of first feature maps and associated with one of the classes from L first feature maps that are outputs of a specific layer of the machine learning model, M and N being integers equal to or greater than 1, L being the number of channels, the first feature vector being obtained by vectorizing a feature amount included in L first feature maps along a channel direction, (b) processing for executing the processing (a) using each of the plurality of pieces of input data belonging to one of the classes as an input, (c) processing for executing the processing (b) for each of the plurality of classes to generate, for each class, a known feature vector group including a set of the first feature vectors associated with the classes, (d) processing for receiving a designation of a range serving as a similarity calculation target in discrimination target data different from the input data, the discrimination target data being discrimination target data input to the machine learning model, (e) processing for inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction, (f) processing for associating information indicating a position in the second feature map that is an output of the specific layer with each of the second feature vectors included in the set of second feature vectors acquired in processing (e), and (g) processing for calculating a similarity between the designated range in the discrimination target data and at least one of the classes using the set of second feature vectors acquired in the processing (e) and the known feature vector group of at least one of the classes.

### BRIEF DESCRIPTION OF THE DRAWINGS

FIG. 1 is a block diagram illustrating an evaluation system in an embodiment.

FIG. 2A is an explanatory diagram illustrating a configuration of a machine learning model (ResNet).

FIG. 2B is an explanatory diagram illustrating a configuration of a machine learning model (WideResNet).

FIG. 3A is an explanatory diagram illustrating a configuration of an intermediate layer and an output layer of the machine learning model in FIG. 2A.

FIG. 3B is an explanatory diagram illustrating a configuration of the intermediate layer and the output layer of the machine learning model in FIG. 2B.

FIG. 4 is an explanatory diagram illustrating an example of a residual block.

FIG. 5 is a flowchart showing processing related to a process of generating a known feature vector group.

FIG. 6 is an explanatory diagram illustrating a configuration of a known feature vector group.

FIG. 7 is a flowchart showing a first half of processing related to a process for an evaluation process for the machine learning model.

FIG. 8 is a flowchart showing a second half of processing related to a process for the evaluation process of the machine learning model.

FIG. 9 is an image of a similarity map represented in an aspect of a heat map.

### DESCRIPTION OF EMBODIMENTS

### A. Embodiment

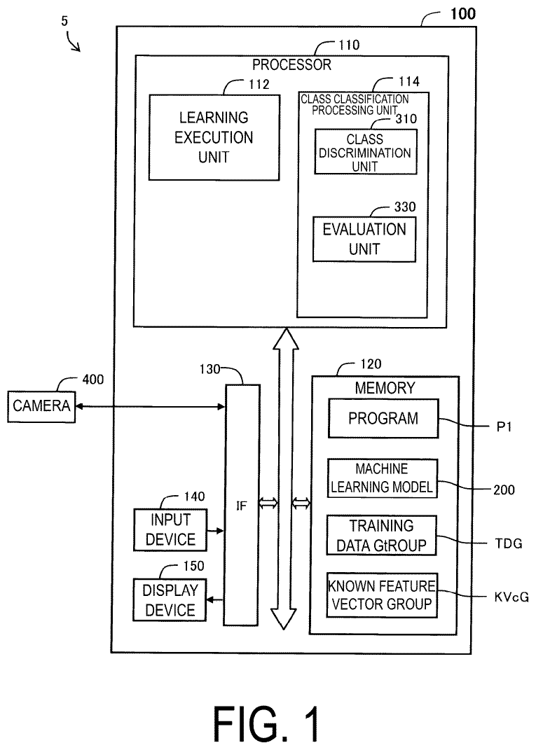

FIG. 1 is a block diagram illustrating an evaluation system 5 in an embodiment. This evaluation system 5 includes an information processing device 100 and a camera 400. The camera 400 captures an image of a target object. The camera 400 may be a camera that captures color images, or a camera that captures monochrome images or spectral images. The captured image captured by the camera 400 is input to a machine learning model.

The information processing device 100 is a computer including a processor 110, a memory 120, an interface circuit 130, and an input device 140 and a display device 150 coupled to the interface circuit 130. The camera 400 is also coupled to the interface circuit 130.

The processor 110 functions as a learning execution unit 112 and a class classification processing unit 114 by executing a program P1 stored in the memory 120. The learning execution unit 112 executes learning processing for a machine learning model 200 using the training data group TDG. The trained machine learning model 200 determines which of a plurality of classes the input image IM is classified into. The class classification processing unit 114 includes a class discrimination unit 310 and an evaluation unit 330. The class discrimination unit 310 inputs the input image IM to the machine learning model 200 and discriminates the class to which the input image IM belongs. The evaluation unit 330 uses intermediate data of the machine learning model 200 to generate descriptive information used for evaluation of a class discrimination result of the trained machine learning model 200. The processor 110 not only executes processing to be described below, but also has a function of displaying data obtained by the processing and data generated in a process of the processing on the display device 150.

The program P1, the machine learning model 200, the training data group TDG, and the known feature vector group KVcG are stored in the memory 120. The training data group TDG is also called a “training data set”. A configuration of the machine learning model 200 will be described in detail later.

The training data group TDG includes a plurality of pieces of the training data TD, which are teacher data. The training data group TDG is a set of pairs of input image IM and a prior label LB associated with the input image IM. In the present embodiment, the prior label LB is a label indicating a type of target object. The input image IM is also called “input data”. In the present embodiment, a handwritten number image of MNIST is used as the input image IM. A number represented by the input image IM becomes the prior label LB associated with the input image IM. For example, when the input image IM is a handwritten number image representing “2”, the prior label associated with this input image IM is “2”. In the present embodiment, “label” and “class” have the same meaning.

The known feature vector group KVcG is a set of feature vectors obtained when the training data group TDG is input to the trained machine learning model 200. Details of the known feature vector group KVcG will be described later.

### Application to ResNet

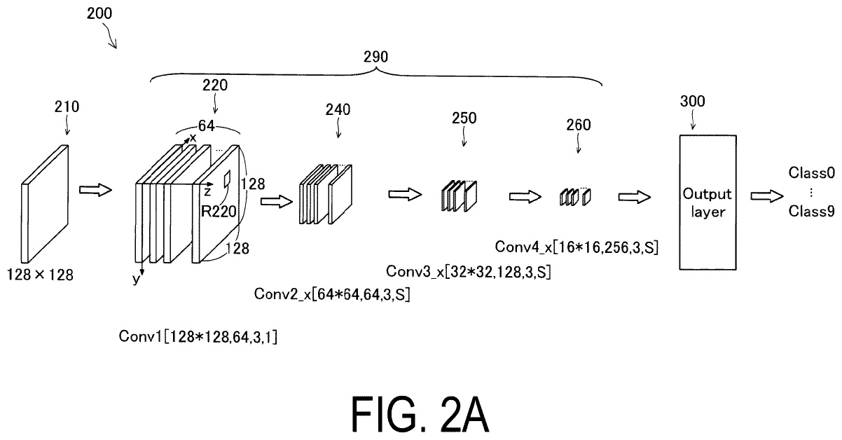

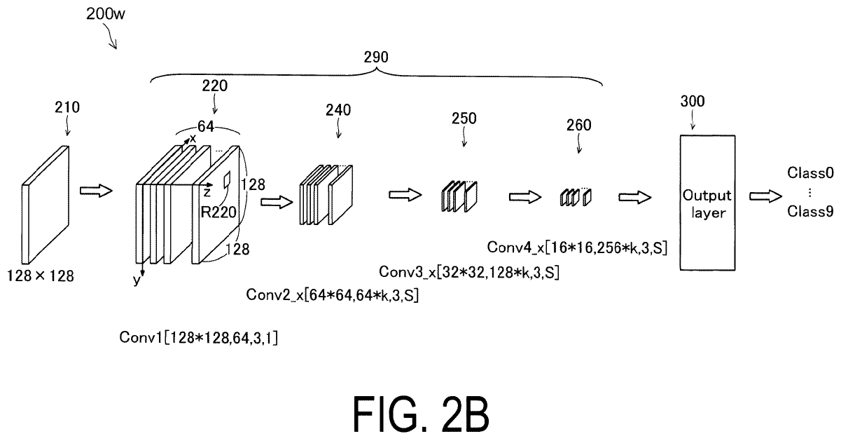

FIG. 2A is an explanatory diagram illustrating an overview of the configuration of the machine learning model 200. This machine learning model 200 is a convolutional neural network in which an input layer 210, an intermediate layer 290, and an output layer 300 are disposed in this order. More specifically, the machine learning model 200 is a residual neural network (ResNet). The input layer 210 that receives the input image is a lowest layer. The output layer 300 is a highest layer. Although details will be described later, the intermediate layer 290 includes a plurality of convolutional layers that extract features of the input image IM. Each layer of the machine learning model 200 includes scalar neurons. Hereinafter, the term “node” is used as a higher-level concept of neurons.

### Application to WideResNet

FIG. 2B is an explanatory diagram illustrating an overview of another configuration 200w of the machine learning model 200. This machine learning model 200w is a convolutional neural network in which the input layer 210, the intermediate layer 290, and the output layer 300 are disposed in this order. More specifically, the machine learning model 200w is a WideResNet (Wide Residual Network) in which the number of channels of a residual neural network (ResNet) is increased. It is known that in WideResNet, the calculation efficiency can be improved without deepening the layers by increasing the number of channels to decrease a depth of the layers. The input layer 210 that receives the input image is a lowest layer. The output layer 300 is a highest layer. Although details will be described later, the intermediate layer 290 includes a plurality of convolutional layers that extract the features of the input image IM. Each layer of the machine learning model 200w includes scalar neurons. Hereinafter, the term “node” is used as a higher-level concept of neurons.

In FIGS. 2A and 2B, the intermediate layer 290 includes a first convolutional layer 220, a second convolutional block 240, a third convolutional block 250, and a fourth convolutional block 260. The convolutional block includes a plurality of convolutional layers. In the following description, the first convolutional layer 220, the second convolutional block 240, the third convolutional block 250, and the fourth convolutional block 260 are referred to as a “Conv1 layer 220”, a “Conv2_x layer 240”, a “Conv3_x layer 250”, and a “Conv4_x layer 260”. Further, the first convolutional layer 220, the second convolutional block 240, the third convolutional block 250, and the fourth convolutional block 260 may also be referred to simply as a “layer”.

In FIGS. 2A and 2B, a first axis x and a second axis y defining planar coordinates of a node array and a third axis z indicating a depth are shown. Sizes in x and y directions are called “resolution”. A size in a z direction is the number of channels. In FIGS. 2A and 2B, for example, sizes in the x, y, and z directions of the first convolutional layer 220 are shown to be 128, 128, and 64. The three axes x, y, and z are also used as coordinate axes indicating a position of each node in other layers. However, in FIGS. 2A and 2B, illustration of these axes x, y, and z is omitted in layers other than the Conv1 layer 220.

Resolution W1 after convolution is calculated by the following formula. Here, W0 indicates resolution before convolution, Wk indicates a surface size of a kernel, S indicates a stride, and P indicates padding. Ceil{X} is a function of performing an operation of rounding up a decimal point of X. The kernel is a coefficient matrix that is used to perform a convolution operation. The kernel is sometimes called a filter. In the present embodiment, since image data is input to the machine learning model 200 or 200w, the surface size of the kernel is also two-dimensional. A value of a parameter of each layer is an example and can be changed arbitrarily. Further, in the embodiment, although an example in which a shape of the kernel is a square will be described, the shape of the kernel may be a rectangle.

W1=Ceil{(W0+2P−Wk+1)/S} (A1)

In the description of each of these layers, a character string before the parentheses is a layer name, and the numbers in the parentheses are an output size, the number of channels, the size of the kernel, and the stride in order. For example, the Conv1 layer 220 is described as Conv1[128*128, 64, 3, 1]. This indicates that a layer name of the Conv1 layer 220 is “Conv1”, the output size is 128×128 pixels, the number of channels is 64, the size of the kernel is 3×3, and the stride is 1. In FIGS. 2A and 2B, these parameters are shown under each layer. As will be described in detail later, the Conv2_x layer 240, the Conv3_x layer 250, and the Conv4_x layer 260 have a plurality of convolutional layers. Since the stride may be different in each convolutional layer, the stride is described as “S”.

In FIGS. 2A and 2B, resolution of each layer when a size of the input image IM is 128×128 pixels is shown. A size of intermediate data output from each layer is changed appropriately depending on the size of the input image IM.

The input image IM with the size of 128×128 pixels is input to the Conv1 layer 220. The input image IM is a grayscale image. The input image IM has information of one channel. When the input image IM is an RGB image, the input image IM contains information of three bands of wavelength. In this case, the input image IM has three-dimensional (three-channel) information.

As illustrated in FIGS. 2A and 2B, convolution with a kernel size of 3×3, a stride of 1, and padding of 1 is executed in the Conv1 layer 220. The Conv1 layer 220 outputs intermediate data with a size of 128×128 pixels and the number of channels of 64. Intermediate data output from the convolutional layer is also called a feature map. In the present embodiment, the feature map is represented by a two-dimensional array. The number of channels represents the number of feature maps output from the convolutional layer.

The Conv2_x layer 240, the Conv3_x layer 250, and the Conv4_x layer 260 each have a residual block.

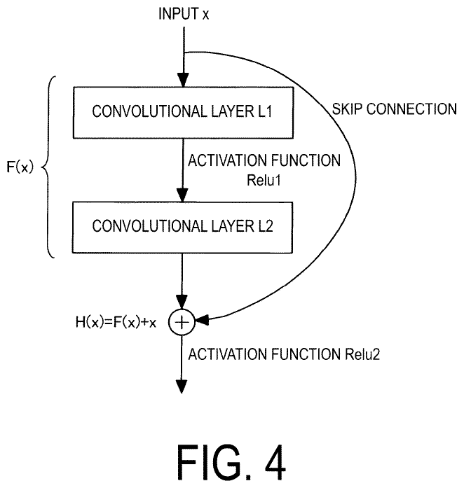

FIG. 4 is an explanatory diagram illustrating an example of the residual block. In the example illustrated in FIG. 4, one residual block includes two convolutional layers L1 and L2 coupled in series and activation functions ReLU1 and ReLU2. An output of the first convolutional layer L1 is input to the convolutional layer L2 after an activation function ReLU1 is applied. An input to the convolutional layer L1 is added to an output of the convolutional layer L2 by a skip connection (residual connection). It is known that use of the residual block is a solution to a gradient vanishing problem due to multi-layering of a configuration of the machine learning model. Although an example of a Plain Block structure is illustrated in FIG. 4, a residual block with a Bottleneck structure may also be used.

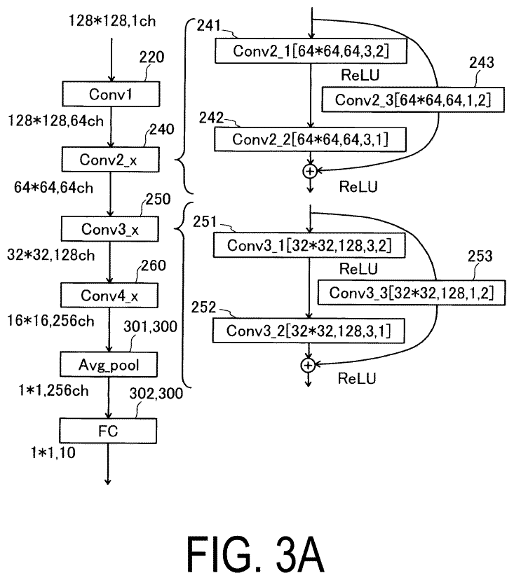

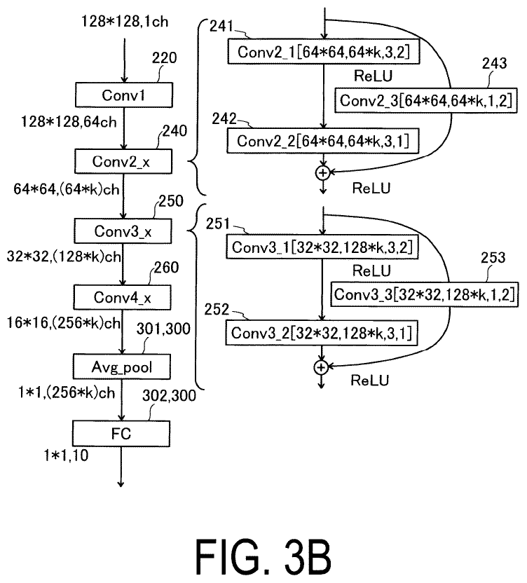

FIG. 3A is an explanatory diagram illustrating a configuration of the intermediate layer 290 and the output layer 300 of the machine learning model (ResNet) in FIG. 2A. The Conv2_x layer 240 is configured as a residual block. The Conv2_x layer 240 includes a convolutional layer 241, a convolutional layer 242, and a convolutional layer 243. The convolutional layers 241 to 243 are called “Conv2_1 layer 241”, “Conv2_2 layer 242”, and “Conv2_3 layer 243”, respectively. In the present embodiment, a convolutional layer is also provided in the skip connection. Accordingly, downsampling is also executed along with the skip connection. Further, in the Conv2_1 layer 241, convolution with a kernel size of 3×3, a stride of 2, and padding of 1 is executed. In the Conv2_2 layer 242, convolution with a kernel size of 3×3, a stride of 1, and padding of 1 is executed. In the Conv2_3 layer 243, convolution with a kernel size of 1×1, a stride of 2, and padding 0 is executed. The Conv2_1 layer 241, the Conv2_2 layer 242, and the Conv2_3 layer 243 each output intermediate data having a size of 64×64 pixels and the number of channels of 64. Therefore, intermediate data having a size of 64×64 pixels and the number of channels of 64 is output from the Conv2_x layer 240. A convolutional layer may not be provided in the skip connection.

FIG. 3B is an explanatory diagram illustrating a configuration of the intermediate layer 290 and the output layer 300 of the machine learning model (WideResNet) in FIG. 2B. The Conv2_x layer 240 is configured as a residual block. The Conv2_x layer 240 includes a convolutional layer 241, a convolutional layer 242, and a convolutional layer 243. The convolutional layers 241 to 243 are called “Conv2_1 layer 241”, “Conv2_2 layer 242”, and “Conv2_3 layer 243”, respectively. In the present embodiment, a convolutional layer is also provided in the skip connection. As a result, downsampling is also executed along with the skip connection. Further, in the Conv2_1 layer 241, convolution with a kernel size of 3×3, a stride of 2, and padding of 1 is executed. In the Conv2_2 layer 242, convolution with a kernel size of 3×3, a stride of 1, and padding of 1 is executed. In the Conv2_3 layer 243, convolution with a kernel size of 1×1, a stride of 2, and padding of 0 is executed. The Conv2_1 layer 241, the Conv2_2 layer 242, and the Conv2_3 layer 243 each output intermediate data with a size of 64×64 pixels and the number of channels of 64×k. Therefore, intermediate data with a size of 64×64 pixels and the number of channels of 64×k (k is an integer equal to or greater than 2) is output from the Conv2_x layer 240. A convolutional layer may not be provided in the skip connection.

The intermediate data output by the immediately preceding Conv1 layer 220 is input to the Conv2_1 layer 241. An output of the Conv2_1 layer 241 is input to the Conv2_2 layer 242 through the activation function ReLU. A sum of an output of the Conv2_2 layer 242 and an output of the Conv2_3 layer 243 is input to the Conv3_x layer 250 through the activation function ReLU.

In FIG. 3A, the Conv3_x layer 250 is configured as a residual block. The Conv3_x layer 250 includes a convolutional layer 251, a convolutional layer 252, and a convolutional layer 253. The convolutional layers 251 to 253 are called a “Conv3_1 layer 251”, a “Conv3_2 layer 252”, and a “Conv3_3 layer 253”, respectively. In the Conv3_1 layer 251, convolution with a kernel size of 3×3, a stride of 2, and padding of 1 is executed. In the Conv3_2 layer 252, convolution with a kernel size of 3×3, stride of 1, and padding of 1 is executed. In the Conv3_3 layer 253, convolution with a kernel size of 1×1, stride of 2, and padding of 0 is executed. The Conv3_1 layer 251, the Conv3_2 layer 252, and the Conv3_3 layer 253 each output intermediate data with a size of 32×32 pixels and the number of channels of 128. Therefore, intermediate data with a size of 32×32 pixels and the number of channels of 128 is output from the Conv3_x layer 250.

In FIG. 3B, the Conv3_x layer 250 is configured as a residual block. The Conv3_x layer 250 includes a convolutional layer 251, a convolutional layer 252, and a convolutional layer 253. The convolutional layers 251 to 253 are referred to as a “Conv3_1 layer 251”, a “Conv3_2 layer 252”, and a “Conv3_3 layer 253”, respectively. In the Conv3_1 layer 251, convolution with a kernel size of 3×3, a stride of 2, and a padding of 1 is executed. In the Conv3_2 layer 252, convolution with a kernel size of 3×3, a stride of 1, and a padding of 1 is executed. In the Conv3_3 layer 253, convolution with a kernel size of 1×1, a stride of 2, and a padding of 0 is executed. The Conv3_1 layer 251, the Conv3_2 layer 252, and the Conv3_3 layer 253 each output intermediate data with a size of 32×32 pixels and the number of channels of 128×k. Therefore, intermediate data having a size of 32×32 pixels and the number of channels of 128×k (k is an integer equal to or greater than 2) is output from the Conv3_x layer 250.

In FIGS. 3A and 3B, the intermediate data output by the Conv2_x 240 is input to the Conv3_1 layer 251. An output of the Conv3_1 layer 251 is input to the Conv3_2 layer 252 through the activation function ReLU. A sum of an output of the Conv3_2 layer 252 and an output of the Conv3_3 layer 253 is input to the Conv4_x layer 260 through the activation function ReLU.

In FIG. 3A, the third convolutional block 250 outputs the intermediate data having a size of 32×32 pixels and the number of channels of 128.

In FIG. 3B, the third convolutional block 250 outputs intermediate data having a size of 32×32 pixels and the number of channels of 128×k (k is an integer equal to or greater than 2). As described above, intermediate data having a size of 64×64 pixels is input to the third convolutional block 250 (Conv3_x layer 250). Thus, in the third convolutional block 250 (Conv3_x layer 250) of the present embodiment, the resolution of the image is reduced to half by the three convolutional layers.

In FIG. 3A, the Conv4_x layer 260 is configured as a residual block. A configuration of each layer in the Conv4_x layer 260 is the same as that of the Conv3_x layer 250, except for the size of the intermediate data output by each layer and number of channels. The Conv4_x layer 260 outputs intermediate data with a size of 16×16 pixels and the number of channels of 256.

In FIG. 3B, the Conv4_x layer 260 is configured as a residual block. A configuration of each layer in the Conv4_x layer 260 is the same as that of the Conv3_x layer 250, except for a size of the intermediate data output by each layer and the number of channels. The Conv4_x layer 260 outputs intermediate data with a size of 16×16 pixels and the number of channels of 256×k (k is an integer equal to or greater than 2). Thus, in the fourth convolutional block 260 (Conv4_x layer 260), the resolution of the image is also reduced by half by three convolutional layers.

Thus, the machine learning models 200 and 200w are configured to reduce the size of the feature map and increase the number of channels each time the model passes through a convolutional layer.

In FIG. 3A, the output layer 300 includes a pooling layer 301 and a fully coupled layer 302. The pooling layer 301 is denoted as an “Avg_pool layer 301”. The fully coupled layer 302 is denoted as an “FC layer 302”. The Avg_pool layer 301 is a global average pooling (GAP) layer. In the Avg_pool layer 301, an output of the immediately preceding convolutional layer is used to calculate an average of the feature map for each channel, and the calculated average value is output as a vector. The size of the feature map output by the Conv4_x layer 260 is 16×16 pixels, and the number of channels is 256. In this case, the Avg_pool layer 301 calculates an average of the feature map of 16×16 pixels for each channel. As a result, an output of the Avg_pool layer 301 is one-dimensional 256 channels.

In FIG. 3B, the C output layer 300 includes a pooling layer 301 and a fully coupled layer 302. The pooling layer 301 is indicated as an “Avg_pool layer 301”. The fully coupled layer 302 is indicated as “FC layer 302”. The Avg_pool layer 301 is a global average pooling (GAP) layer. In the Avg_pool layer 301, an output of the immediately preceding convolutional layer is used to calculate the average of the feature map for each channel, and the calculated average value is output as a vector. The size of the feature map output by the Conv4_x layer 260 is 16×16 pixels, and the number of channels is 256×k (k is an integer equal to or greater than 2). In this case, the Avg_pool layer 301 obtains an average of the feature map of 16×16 pixels for each channel. As a result, the output of the Avg_pool layer 301 is one-dimensional, 256 channels k (k is an integer equal to or greater than 2).

In FIG. 3A or FIG. 3B, the FC layer 302 outputs a discrimination result for the class into which the input image IM is classified based on the output of the Avg_pool layer 301. As illustrated in FIG. 2A or FIG. 2B, the output layer 300 includes CL channels. CL is the number of classes discriminated by the machine learning model 200 or 200w. Any integer value can be set as CL. In the present embodiment, CL is 10. A value obtained by applying a Softmax function to the output of the FC layer 302 can be used as a class discrimination value. Class discrimination values Class_0 to Class_9 corresponding to the 10 classes range from 0 to 1. A sum of the class discrimination values Class_0 to Class_9 is 1. Thus, 10 class discrimination values Class_0 to Class_9 are obtained as the output of the machine learning model 200 or 200w. The class determination values Class_0 to Class_9 correspond to a probability of the class predicted for the input data. For example, the class indicated by the class determination value having the largest value may be output as the class into which the input image IM is classified.

Alternatively, even when the Softmax function is not applied to the output of the FC layer 302, it is possible to perform class discrimination for each class using a maximum value of the output of the FC layer 302.

The known feature vector group KVcG includes a set of feature vectors that are collected when the training data group TDG is input to the trained machine learning model 200 or 200w. The feature vector is obtained by vectorizing the feature amount in one partial region Rn from the feature maps whose number corresponds to the number of channels output as the intermediate data.

As illustrated in FIGS. 2A and 2B, the partial region Rn is drawn in the Conv1 layer 220. A subscript “n” of the partial region Rn is a code of each layer. In FIGS. 2A and 2B, only a partial region of the Conv1 layer 220 is illustrated. A partial region R220 indicates a partial region in the first convolutional layer 220. The “partial region Rn” is a region in each layer that is specified by a planar position (x, y) defined by a position of the first axis x and a position of the second axis y and includes a plurality of channels along the third axis z. The partial region Rn has dimensions of “Width” “Height”×“Depth” corresponding to the first axis x, the second axis y, and the third axis z. Vectorizing the feature amount in one partial region Rn along the channel direction means acquiring the feature amount in the partial region Rn in each feature map corresponding to each channel, and generating an array of the acquired feature amounts. In the present embodiment, one “partial region Rn” is expressed as “1 1×depth number”, that is, “1 1 channel number”. From the feature maps whose number corresponds to the number of channels output by each layer, feature vectors having a length corresponding to the number of channels can be collected in the number corresponding to the size of the feature maps. In FIG. 2, only the partial region in the first convolutional layer 220 is illustrated, but the same applies to the Conv2_x layer 240, the Conv3_x layer 250, and the Conv4_x layer 260.

In FIG. 2A, for example, the size of the feature map output from the Conv2_x layer 240 is 64×64 pixels. Also, since the number of channels is 64, 64 feature maps are output. In this case, only 64×64 feature vectors having a length of 64 can be collected from the output of the Conv2_x layer 240.

In FIG. 2B, for example, the size of the feature map output from the Conv2_x layer 240 is 64×64 pixels. Also, since the number of channels is 64k (k is an integer equal to or greater than 2), 64k feature maps are output. In this case, 64×64 feature vectors with a length of 64k can be collected from the output of the Conv2_x layer 240.

Also, in FIG. 2A, for example, the size of the feature map output by the Conv3_x layer 250 is 32×32 pixels. Since the number of channels is 128, 128 feature maps are output. Only 32×32 feature vectors having a length of 128 can be collected from the output of the Conv3_x layer 250. The number of feature vectors that can be collected is expressed as M×N (M and N are integers equal to or greater than 1).

Also, in FIG. 2B, for example, the size of the feature map output by the Conv3_x layer 250 is 32×32 pixels. Since the number of channels is 128×k (k is an integer equal to or greater than 2), 128×k (k is an integer equal to or greater than 2) feature maps are output. Only 32×32 feature vectors having a length of 128×k can be collected from the output of the Conv3_x layer 250. The number of feature vectors that can be collected is expressed as M×N (M and N are integers equal to or greater than 1).

A feature vector obtained by inputting the training data TD to the machine learning model 200 or 200w is called a first feature vector Vc1.

In the present embodiment, the first feature vector Vc1 is obtained from the specific layer of the machine learning model 200 or 200w. A feature map used to acquire the first feature vector Vc1 and output from the specific layer is also called a “first feature map”. In the present embodiment, the layer immediately before the convolutional layer in which downsampling is executed is selected as the specific layer. The specific layer may include two or more intermediate layers. In the configuration illustrated in FIG. 3, for example, a sum of an output of the Conv3_2 layer 252 and the output of the Conv3_3 layer 253 is the output from the specific layer.

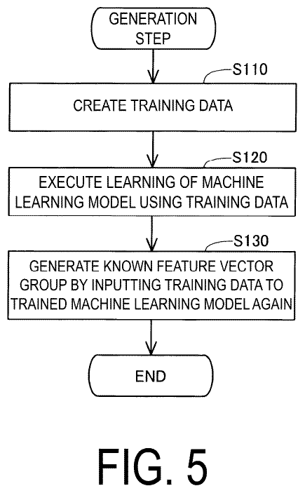

FIG. 5 is a flowchart showing processing related to a process of generating a known feature vector group KVcG. The processing illustrated in FIG. 5 is started when, for example, an operation instruction from the user is received via the input device 140. The processing illustrated in FIG. 5 is executed by the processor 110 functioning as the learning execution unit 112. In step S110, the processor 110 creates the training data TD by associating the number represented by the input image IM as the prior label LB with the handwritten number image of MNIST as the input image IM. In the present embodiment, a handwritten number image representing 0 to 9 is used as the input image IM. The prior labels LB associated with the respective handwritten number images are “0” to “9”. The number of classes is 10. 1000 pieces of training data TD are prepared for each class. The total number of the training data TD is 10000. The 10000 pieces of training data TD are stored in the memory 120 as the training data group TDG.

In step S120, the processor 110 executes learning of the machine learning model 200 or 200w using the training data group TDG. Any loss function can be used at the time of learning, but in the present embodiment, cross entropy is used. When the learning is completed, data representing the trained machine learning model 200 or 200w is stored in the memory 120.

In step S130, the processor 110 inputs the training data TD included in the training data group TDG to the trained machine learning model 200 or 200w again to generate the known feature vector group KVcG. The processor 110 stores the known feature vector group KVcG in the memory 120.

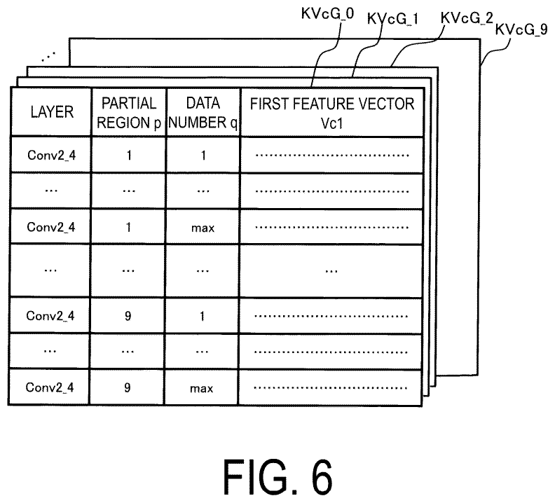

FIG. 6 is an explanatory diagram illustrating a configuration of the known feature vector group KVcG. In this example, the known feature vector group KVcG is a set of first feature vectors Vc1 obtained from the output of the Conv2_x layer 240.

Each record of the known feature vector group KVcG includes a parameter p indicating an order of the partial region Rn in the feature map, a parameter q indicating a data number, and the first feature vector Vc1. The parameter p, which indicates the order of partial regions Rn, has a value indicating a plane position (x, y) in the feature map, which is intermediate data output from the specific layer. For example, since the size of the feature map output by the Conv2_x layer 240 is 64×64 pixels, p=1 to 4096. The parameter q, which is the data number, indicates a consecutive number for identifying the training data TD. q has a value of 1 to max. For example, max=1000. FIG. 6 illustrates an example of the known feature vector group KVcG, and each record of the known feature vector group KVcG may not include the parameters p and q.

The known feature vector group KVcG is generated for each class. In FIG. 6, a set of known feature vector groups KVcG corresponding to classes “0” to “9” is shown. For example, a known feature vector group KVcG_Class0 indicates that this is the known feature vector group KVcG generated using the training data TD belonging to class “0”. A known feature vector group KVcG_Class1 indicates that this is the known feature vector group KVcG generated using the training data TD belonging to class “1”.

The plurality of the training data TD used in step S130 (see FIG. 5) of a preparation process does not need to be the same as the plurality of the training data TD used in step S120. However, there is an advantage that it is not necessary to prepare new teacher data in step S130 when some or all of the plurality of teacher data used in step S120 are used.

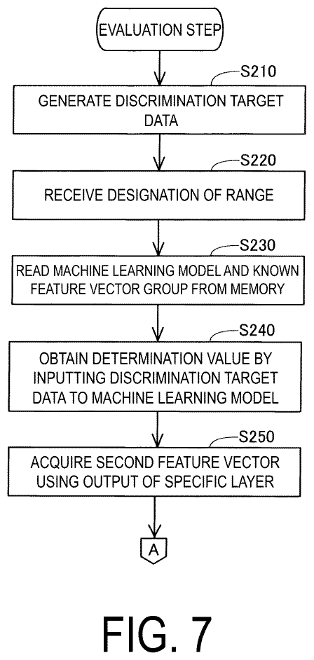

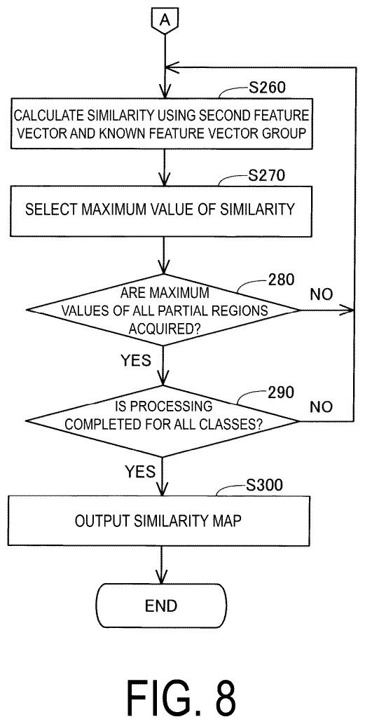

FIGS. 7 and 8 are flowcharts showing processing related to a process of evaluating the machine learning model 200 or 200w. The evaluation process can be executed after the preparation process illustrated in FIG. 5 ends. The processing illustrated in FIG. 7 is started, for example, when an operation instruction from a user is received via the input device 140.

In step S210, the processor 110 functioning as the class discrimination unit 310 generates a discrimination target data ID. In the present embodiment, a character image of 128×128 pixels is created as the discrimination target data ID by photographing handwritten characters using the camera 400. In step S210, the processor 110 executes preprocessing for the discrimination target data ID as necessary. The preprocessing is processing such as resolution adjustment and data normalization (min-max normalization). The preprocessing can be omitted. In step S220, the processor 110 receives a designation of a range that is a similarity calculation target in the discrimination target data ID. In the present embodiment, it is assumed that an entire range of the discrimination target data ID is designated. In step S230, the processor 110 reads the trained machine learning model 200 or 200w and the known feature vector group KVcG from the memory 120.

In step S240, the processor 110 inputs the discrimination target data ID to the machine learning model 200 or 200w to obtain class determination values Class_0 to Class_9.

In step S250, the class classification processing unit 114 functioning as the evaluation unit 330 acquires a second feature vector Vc2 using the output of the specific layer. The feature vector obtained by inputting the discrimination target data ID to the machine learning model 200 or 200w is called a second feature vector. The feature map used to acquire the second feature vector Vc2 and output from the specific layer is also called a “second feature map”.

As described above, in the present embodiment, the layer immediately before the convolutional layer in which downsampling is executed is selected as the specific layer. For example, the output of the specific layer is a sum of the output of the Conv3_2 layer 252 and the output of the Conv3_3 layer 253.

In FIG. 3A, a size of the feature map output from the Conv3_x layer 250 is 32×32 pixels. The number of channels is 128. Therefore, 32×32 feature vectors can be acquired from the output of the Conv3_x layer 250. A length of the feature vector is 128. In step S250, the acquired second feature vector Vc2 is stored in the memory 120 together with a value indicating the planar position (x, y) of the “partial region Rn” in the feature map, which is the output of the specific layer.

In FIG. 3B, the size of the feature map output from the Conv3_x layer 250 is 32×32 pixels. The number of channels is 128×k (k is an integer equal to or greater than 2). Therefore, 32×32 feature vectors can be acquired from the output of the Conv3_x layer 250. The length of the feature vector is 128×k. In step S250, the acquired second feature vector Vc2 is stored in the memory 120 together with a value indicating the planar position (x, y) of the “partial region Rn” in the feature map, which is the output of the specific layer.

As illustrated in FIG. 8, in step S260, the processor 110 calculates a similarity between one of the plurality of second feature vectors Vc2 obtained in step S250 and each first feature vector Vc1 of the known feature vector group KVcG belonging to one class. Specifically, a similarity between one of the plurality of second feature vectors Vc2 obtained in step S250 and the first feature vector Vc1 of each record (see FIG. 6) of the known feature vector group KVcG belonging to one class is calculated. For example, when the known feature vector group KVcG includes 1000 first feature vectors Vc1, 1000 similarities are calculated. Also, for example, the cosine similarity is obtained as the similarity. The cosine similarity is obtained by dividing an inner product of two vectors by a norm of each vector. The process of step S260 is executed within the range designated in step S220.

In step S270, the processor 110 selects the similarity having a maximum value from among the plurality of similarities calculated in step S260. Here, the similarity having the maximum value is selected as a representative value from among the plurality of calculated similarities. The selected similarity is stored in the memory 120 together with a value indicating the planar position (x, y) in the feature map of the partial region Rn related to the second feature vector Vc2 and a value indicating the class. In step S270, the selected similarity having the maximum value indicates similarity between the second feature vector Vc2 located in the partial region Rn and the most similar first feature vector Vc1 in the set of first feature vectors Vc1 belonging to one class.

In step S280, the processor 110 determines whether processing related to the calculation of the similarities and the selection of the maximum value has been completed for all “partial regions Rn” in the feature map output from the specific layer.

The processes after step S260 are repeated until the process of step S260 and the process of S270 are completed for all “partial regions Rn” (step S280; NO). When the process of step S260 and the process of step S270 are completed for all “partial regions Rn” (step S280; YES), the process of step S290 is executed.

In step S290, the processor 110 determines whether the processes related to the calculation of the similarity and the selection of the maximum value have been completed for all classes. Until the process of step S260 and the process of step S270 are completed for all the classes (step S290; NO), the processes after step S260 are repeated. When the processes after step S260 are completed for all the classes (step S290; YES), the process of step S300 is executed.

In step S300, the processor 110 outputs a similarity map for each class. The similarity map is obtained by disposing a maximum similarity of each partial region Rn at a planar position in the feature map of the partial region Rn.

Further, the processor 110 may perform a display on the display device 150 in a visually recognizable aspect of the similarity map for each class. Here, an example in which the similarity map is represented as a heat map will be described.

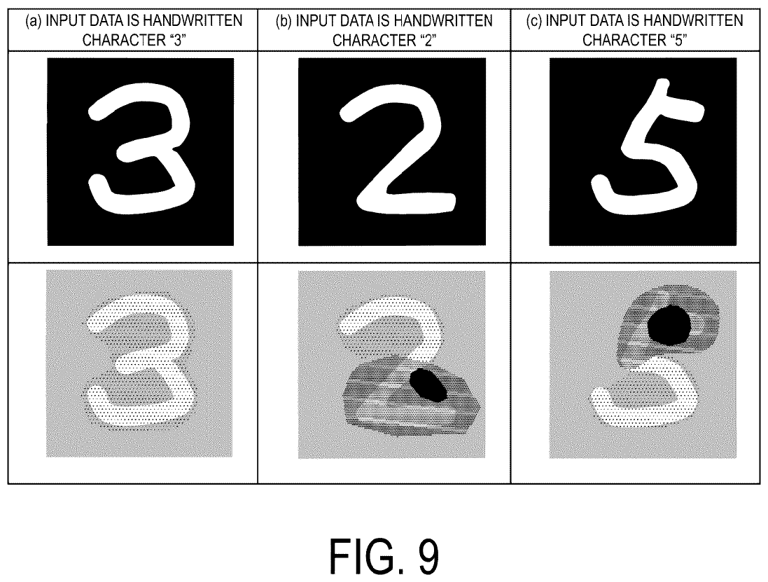

FIG. 9 is an image diagram of a similarity map expressed in the aspect of the heat map. The cosine similarity has a value from −1 to 1. Further, when the cosine similarity is closer to 1, the similarity is higher, and when the cosine similarity is closer to −1, the similarity is lower. Therefore, for example, each partial region Rn is expressed in a brighter color the closer the cosine similarity value is to 1, and in a darker color the closer the cosine similarity value is to −1. In FIG. 9, an example in which a similarity map is created by calculating the similarity between the second feature vector Vc2 acquired using the discrimination target and the first feature vector Vc1 of the known feature vector group KVcG of class “3” is shown.

An upper left part of FIG. 9 illustrates an image of a handwritten character “3”, which is the discrimination target data ID. A lower left part of FIG. 9 illustrates (a) a similarity map generated using the image of the handwritten character “3”. To facilitate understanding of the technology, the handwritten character “3” of the discrimination target data ID is superimposed on the similarity map. An upper center part of FIG. 9 illustrates an image of a handwritten character “2” which is the discrimination target data ID. A lower center part of FIG. 9 illustrates (b) a similarity map generated using the image of the handwritten character “2”. The handwritten character “2” of the discrimination target data ID is superimposed on the similarity map. An upper right part of FIG. 9 illustrates an image of a handwritten character “5” which is the discrimination target data ID. A lower right part of FIG. 9 illustrates (c) a similarity map generated using an image of the handwritten character “5”. The handwritten character “5” of the discrimination target data ID is superimposed on the similarity map.

As illustrated in FIG. 9, in the case of (a), since a shape of the handwritten character “3” of the discrimination target data ID and a shape of a number “3” represented by the class are substantially the same, there are no dark colored parts on the similarity map. In the case of (b), in a range of a lower half of the handwritten character “2” of the discrimination target data ID, there is a part that is greatly different in shape from the number “3” represented by the class. Therefore, a lower half of the similarity map includes a part colored in a dark color. In the case of (c), in a range of an upper half of the handwritten character “5” of the discrimination target data ID, there is a part that is greatly different in shape from the number “3” represented by the class. Therefore, an upper half of the similarity map includes a part colored in a dark color. When such a similarity map is generated, it is conceivable that a result of class classification of the machine learning model 200 or 200w is close to the recognition when a person views the handwritten character.

For example, when the similarity map includes a part colored in a dark color in the case of (a) and the similarity map is generally light in color in the cases of (b) and (c), it is expected that the accuracy of processing in the specific layer of the generated machine learning model 200 or 200w or a layer before the specific layer is low.

Further, in the embodiment, although an example in which there is one specific layer has been described, it is possible to generate a similarity map for a plurality of specific layers by selecting two or more layers as the specific layers. It can be said that the closer the specific layer is to the output layer 300, the wider the portion corresponding to the input data for each partial region, and a similarity map for the specific layer represents similarity of features of a global structure. Further, it can be said that the closer the specific layer is to the input layer 210, the narrower the portion corresponding to the input data for each partial region, and the similarity map for the specific layer represents similarity for fine features. Thus, the generated similarity map can be used as descriptive information for class classification.

Further, the similarity map contains information on a position in the feature map of the partial region Rn from which the second feature vector Vc2 of the discrimination target data ID has been acquired, together with the similarity. In the embodiment, an example in which calculation of the similarity for all (entire range) of the discrimination target data ID has been designated has been described. However, the user can designate an arbitrary range rather than the entire range of the discrimination target data ID. When the user designates the arbitrary range of the discrimination target data ID, the information processing device 100 can provide descriptive information about the designated range.

### B. Other Embodiments

### B1

In the embodiment, an example in which an output of a layer immediately before the convolutional layer in which downsampling is executed is selected as the output of the specific layer has been described. Alternatively, the output of the Avg_pool layer 301 may be selected as the output of the specific layer. Alternatively, an output of the Conv4_x layer 260 immediately before the Avg_pool layer 301 may be used as the output of the specific layer. Further, the number of specific layers may not be limited to one.

In the convolutional neural network, the closer to the output layer 300, features of the input data tend to be condensed by convolution. For example, it is possible to describe a behavior of the machine learning model 200 or 200w at positions of selected specific layers by selecting a plurality of different layers as the specific layers.

### B2

In the embodiment, an example in which image data, which is two-dimensional data, is input to the machine learning model 200 or 200w has been described. However, the data input to the machine learning model 200 or 200w may be one-dimensional data or may be time-series data expressed as three-dimensional data. In this case, an input data acquisition device according to a type of data is used instead of the camera 400.

### B3

When the information processing device 100 displays the similarity map as a heat map, the information processing device 100 may display the similarity map on the display device 150 according to the class determination value for the class corresponding to the similarity map among the class determination values Class_0 to Class_9 output by the machine learning model 200 or 200w.

### B4

In the embodiment, an example in which the similarity map is generated for all classes has been described. However, the similarity map may not be generated for all the classes. For example, when a difference between the handwritten character “2” and the handwritten character “3” is considered, the similarity map may be generated using only the known feature vector group KVcG of class “3”.

### B5

The information processing device 100 may also obtain a representative value that quantitatively represents the tendency of similarity in the similarity map for each similarity map of each class, and display the representative value on the display device 150 together with the similarity map. For example, an average value may be used as the representative value. Alternatively, the information processing device 100 may display only the representative value on the display device 150. The similarity map and the representative value may be stored in the memory 120 of the information processing device 100.

Alternatively, the information processing device 100 may not output the similarity map, but may output only the class into which the discrimination target data ID is classified.

### B6

In the embodiment, an example in which the parameter p indicating the order of the partial regions Rn in the feature map is associated with the first feature vector Vc1 included in the known feature vector group KVcG has been described (see FIG. 6). The parameter p indicating the order of the partial regions Rn represents the plane position (x, y) in the feature map, which is the intermediate data output from the specific layer. In the embodiment, an example in which a similarity between the first feature vector Vc1 and the second feature vector Vc2 is calculated regardless of the partial region Rn in the feature map for the first feature vector Vc1 has been described (see step S260 in FIG. 8). Alternatively, when the similarity is calculated, only the first feature vector Vc1 associated with the region corresponding to the partial region Rn in the feature map of the second feature vector Vc2 may be used.

Further, the parameter p indicating the order of the partial regions Rn in the feature map may not be associated with the first feature vector Vc1 included in the known feature vector group KVcG.

### B7

Further, since the training data TD can be identified from the parameter q, the training data TD from which the maximum similarity can be obtained may be indicated for each partial region. For example, when the specific layer is the Avg_pool layer 301 (GAP layer), the most similar training data TD in the training data group TDG can be indicated.

### B8

In the machine learning model 200 of the embodiment related to application to ResNet, a pooling layer may be provided between the first convolutional layer 220 and the second convolutional block 240. This pooling layer may be configured as a max pooling layer.

### B8w

In the embodiment related to application to WideResNet, an example in which the resolution of the image is reduced to half by three convolutional layers in each of the Conv2_x layer 240 and the Conv3_x layer 250 has been described. Alternatively, the resolution of the image may be reduced to half by four or fewer convolutional layers. Also, the resolution of the image may be reduced to half or less by the four or fewer convolutional layers.

### B9

In the machine learning model 200 of the embodiment related to application to ResNet, a pooling layer may be provided between the first convolutional layer 220 and the second convolutional block 240. This pooling layer may be configured as a maximum pooling layer.

### B10

In the embodiment related to application to WideResNet, the number of channels of the intermediate data output from the second convolutional block 240 or the like was 64k, while data output from the first convolutional layer 220 was 64 channels. In other words, the first convolutional layer 220 was not an increase target for the number of channels. However, the first convolutional layer 220 may also be the increase target for the number of channels.

### B11

In the embodiment related to application to ResNet, an example in which cosine similarity is calculated as the similarity between one second feature vector Vc2 among the plurality of second feature vectors Vc2 and each first feature vector Vc1 of the known feature vector group KVcG belonging to one class has been described. Alternatively, the similarity can be expressed using an L2 distance. The L2 distance is also called an Euclidean distance. In the case of the cosine similarity, the larger the value, the higher the similarity, whereas in the case of the L2 distance, the smaller the value, the higher the similarity.

### B12

In the embodiment related to application to WideResNet, an example in which the coefficient k indicating the number of channels in the Conv2_x layer 240 is the same as the coefficient k indicating the number of channels in the Conv3_x layer 250 has been described. However, when the coefficients indicating the number of channels in the Conv2_x layer 240, the Conv3_x layer 250, and the Conv4_x layer 260 are expressed as k1, k2, and k3, respectively, k1, k2, and k3 may be the same value or may be different values.

A means for realizing functions of the information processing device 600 is not limited to software, and may be realized partially or entirely by dedicated hardware. For example, a circuit such as a field programmable gate array (FPGA) or an application specific integrated circuit (ASIC) may be used as the dedicated hardware.

### C. Other Aspects

The present disclosure is not limited to the above-described embodiments, and can be realized in various configurations without departing from the spirit of the present disclosure. For example, technical characteristics in the embodiment corresponding to the technical characteristics in each aspect described in the Summary of the Invention column can be appropriately replaced or combined to solve some or all of the above-described problems or to achieve some or all of the above-described effects. Further, even when technical characteristics are not described as essential ones in the present specification, it is possible to delete the technical characteristics in the embodiments appropriately.
(1) According to a first aspect of the present disclosure, there is provided a method of generating descriptive information regarding a class classification of a machine learning model for classifying classes of input data. The machine learning model is a convolutional neural network including a plurality of residual blocks and including convolutional layers, and is generated by machine learning using a training dataset including a set of pairs of a plurality of pieces of input data and a prior label associated with the input data, the prior label indicating a class to which the input data belongs among a plurality of classes, and the method includes: (a) a step of inputting the input data belonging to one of the classes to the machine learning model again, and acquiring a set of M×N (M and N are integers equal to or greater than 1) first feature vectors corresponding to a size of first feature maps and associated with one of the classes from L (L is the number of channels) first feature maps that are outputs of a specific layer of the machine learning model, the first feature vector being obtained by vectorizing a feature amount included in L first feature maps along a channel direction, (b) a step of executing the step (a) using each of the plurality of pieces of input data belonging to one of the classes as an input, (c) a step of executing the step (b) for each of the plurality of classes to generate, for each class, a known feature vector group including a set of the first feature vectors associated with the classes, (d) a step of receiving a designation of a range serving as a similarity calculation target in discrimination target data different from the input data, the discrimination target data being discrimination target data input to the machine learning model, (e) a step of inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction, (f) a step of associating information indicating a position in the second feature map that is an output of the specific layer with each of the second feature vectors included in the set of second feature vectors acquired in the step (e), and (g) a step of calculating a similarity between the designated range in the discrimination target data and at least one of the classes using the set of second feature vectors acquired in the step (e) and the known feature vector group of at least one of the classes.

According to the aspect, it is possible to provide the similarity related to the class as the descriptive information for the designated range.
(2) In the method of the aspect, the machine learning model further may have a structure in which resolution of data is reduced to half or less by four or fewer convolutional layers.
(3) The method of the aspect may further include (h) a step of outputting a class into which the discrimination target data indicated by the output of the machine learning model is classified.
(4) In the method of the aspect, at least one of the classes in the step (g) may include the class into which the discrimination target data indicated by the output of the machine learning model is classified, and the method may further include (i) a step of outputting at least one of the classes into which the discrimination target data indicated by the output of the machine learning model is classified and the similarity for the class.
(5) In the method of the aspect, the step (g) may include (g1) a step of calculating the similarity between one of the second feature vectors and each of the first feature vectors included in the known feature vector group of one of the classes, (g2) a step of acquiring a maximum value of the plurality of similarities calculated in the step (g1), (g3) a step of executing the steps (g1) and (g2) for M×N second feature vectors, and (g4) a step of acquiring a similarity map representing the similarity regarding one of the classes using the maximum value of each of the M×N second feature vectors acquired by executing the step (g3).
(6) The method of the aspect may further include (j) a step of displaying the similarity map regarding the class in an aspect of a heat map as the similarity for the class.
(7) In the method of the aspect, the step (g) may include (g5) a step of executing the steps (g1), (g2), (g3), and (g4) for two or more of the classes.
(8) The method of the aspect may further include a step of (k) a step of outputting a representative value of the similarity map for each class as information quantitatively indicating a similarity between the discrimination target data and the class.
(9) In the method of the aspect, the specific layer may be a layer immediately before a convolutional layer that executes downsampling by executing a convolutional process with a stride of 2 or more, a global average pooling layer, or a convolutional layer immediately before the global average pooling layer.
(10) In the method of the aspect, the step (a) may include: (a1) a step of inputting the input data belonging to one of the classes to the machine learning model again to acquire a set of first feature vectors, and then associating information indicating a position in the first feature map with each of the first feature vectors included in the set of first feature vectors.
(11) In the method of the aspect, the step (a) may include (a2) a step of inputting the input data belonging to one of the classes to the machine learning model again to acquire a set of first feature vectors, and then associating information for identifying the input data with each of the first feature vectors included in the set of first feature vectors.
(12) According to a second aspect of the present disclosure, there is provided an information processing device for generating descriptive information regarding a class classification of a machine learning model for classifying classes of input data. The machine learning model is a convolutional neural network including a plurality of residual blocks and including convolutional layers, and is generated by machine learning using a training dataset including a set of pairs of a plurality of pieces of input data and a prior label associated with the input data, the prior label indicating a class to which the input data belongs among a plurality of classes, and the information processing device executes: (a) processing for inputting the input data belonging to one of the classes to the machine learning model again, and acquiring a set of M×N (M and N are integers equal to or greater than 1) first feature vectors corresponding to a size of first feature maps and associated with one of the classes from L (L is the number of channels) first feature maps that are outputs of a specific layer of the machine learning model, the first feature vector being obtained by vectorizing a feature amount included in L first feature maps along a channel direction, (b) processing for executing the processing (a) using each of the plurality of pieces of input data belonging to one of the classes as an input, (c) processing for executing the processing (b) for each of the plurality of classes to generate, for each class, a known feature vector group including a set of the first feature vectors associated with the classes, (d) processing for receiving a designation of a range serving as a similarity calculation target in discrimination target data different from the input data, the discrimination target data being discrimination target data input to the machine learning model, (e) processing for inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction, (f) processing for associating information indicating a position in the second feature map that is an output of the specific layer with each of the second feature vectors included in the set of second feature vectors acquired in processing (e), and (g) processing for calculating a similarity between the designated range in the discrimination target data and at least one of the classes using the set of second feature vectors acquired in the processing (e) and the known feature vector group of at least one of the classes.

According to the aspect, it is possible to provide the similarity related to the class as the descriptive information for the designated range.
(13) In the device according to the aspect, the machine learning model may further have a structure in which resolution of data is reduced to half or less by four or fewer convolutional layers.
(14) According to a third aspect of the present disclosure, there is provided a non-transitory computer-readable storage medium storing a program for causing a computer to execute processing for generating descriptive information regarding a class classification of a machine learning model for classifying classes of input data. The machine learning model is a convolutional neural network including a plurality of residual blocks and including convolutional layers, and is generated by machine learning using a training dataset including a set of pairs of a plurality of pieces of input data and a prior label associated with the input data, the prior label indicating a class to which the input data belongs among a plurality of classes, and
the program causes the computer to execute: (a) processing for inputting the input data belonging to one of the classes to the machine learning model again, and acquiring a set of M×N (M and N are integers equal to or greater than 1) first feature vectors corresponding to a size of first feature maps and associated with one of the classes from L (L is the number of channels) first feature maps that are outputs of a specific layer of the machine learning model, the first feature vector being obtained by vectorizing a feature amount included in L first feature maps along a channel direction, (b) processing for executing the processing (a) using each of the plurality of pieces of input data belonging to one of the classes as an input, (c) processing for executing the processing (b) for each of the plurality of classes to generate, for each class, a known feature vector group including a set of the first feature vectors associated with the classes, (d) processing for receiving a designation of a range serving as a similarity calculation target in discrimination target data different from the input data, the discrimination target data being discrimination target data input to the machine learning model, (e) processing for inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction, (f) processing for associating information indicating a position in the second feature map that is an output of the specific layer with each of the second feature vectors included in the set of second feature vectors acquired in processing (e), and (g) processing for calculating a similarity between the designated range in the discrimination target data and at least one of the classes using the set of second feature vectors acquired in the processing (e) and the known feature vector group of at least one of the classes.

According to the aspect, it is possible to provide the similarity related to the class as the descriptive information for the designated range.
(15) In the device according to the aspect, the machine learning model further has a structure in which resolution of data is reduced to half or less by four or fewer convolutional layers.

What is claimed is:

1. A method of generating descriptive information regarding a class classification of a machine learning model for classifying classes of input data, wherein
the machine learning model
is a convolutional neural network including a plurality of residual blocks and including convolutional layers, and
is generated by machine learning using a training dataset including a set of pairs of a plurality of pieces of input data and a prior label associated with the input data, the prior label indicating a class to which the input data belongs among a plurality of classes, and
the method comprises:
(a) a step of inputting the input data belonging to one of the classes to the machine learning model again, and acquiring a set of M×N first feature vectors corresponding to a size of first feature maps and associated with one of the classes from L first feature maps that are outputs of a specific layer of the machine learning model, M and N being integers equal to or greater than 1, L being the number of channels, the first feature vector being obtained by vectorizing a feature amount included in L first feature maps along a channel direction;
(b) a step of executing the step (a) using each of the plurality of pieces of input data belonging to one of the classes as an input;
(c) a step of executing the step (b) for each of the plurality of classes to generate, for each class, a known feature vector group including a set of the first feature vectors associated with the classes;
(d) a step of receiving a designation of a range serving as a similarity calculation target in discrimination target data different from the input data, the discrimination target data being discrimination target data input to the machine learning model;
(e) a step of inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction;
(f) a step of associating information indicating a position in the second feature map that is an output of the specific layer with each of the second feature vectors included in the set of second feature vectors acquired in the step (e); and
(g) a step of calculating a similarity between the designated range in the discrimination target data and at least one of the classes using the set of second feature vectors acquired in the step (e) and the known feature vector group of at least one of the classes.

2. The method according to claim 1, wherein
the machine learning model further has a structure in which a resolution of data is reduced to half or less by four or fewer convolutional layers.

3. The method according to claim 1, further comprising:
(h) a step of outputting a class into which the discrimination target data indicated by the output of the machine learning model is classified.

4. The method according to claim 1, wherein
at least one of the classes in the step (g) includes the class into which the discrimination target data indicated by the output of the machine learning model is classified, and
the method further comprises (i) a step of outputting at least one of the classes into which the discrimination target data indicated by the output of the machine learning model is classified and the similarity for the class.

5. The method according to claim 1, wherein
the step (g) comprises:
(g1) a step of calculating the similarity between one of the second feature vectors and each of the first feature vectors included in the known feature vector group of one of the classes;
(g2) a step of acquiring a maximum value of the plurality of similarities calculated in the step (g1);
(g3) a step of executing the steps (g1) and (g2) for M×N second feature vectors; and
(g4) a step of acquiring a similarity map representing the similarity regarding one of the classes using the maximum value of each of the M×N second feature vectors acquired by executing the step (g3).

6. The method according to claim 5, further comprising:
(j) a step of displaying the similarity map regarding the class in an aspect of a heat map as the similarity for the class.

7. The method according to claim 6, wherein
the step (g) includes (g5) a step of executing the steps (g1), (g2), (g3), and (g4) for two or more of the classes.

8. The method according to claim 7, further comprising:
(k) a step of outputting a representative value of the similarity map for each class as information quantitatively indicating a similarity between the discrimination target data and the class.

9. The method according to claim 1, wherein
the specific layer is a layer immediately before a convolutional layer that executes downsampling by executing a convolutional process with a stride of 2 or more, a global average pooling layer, or a convolutional layer immediately before the global average pooling layer.

10. The method according to claim 9, wherein
the step (a) includes:
(a1) a step of inputting the input data belonging to one of the classes to the machine learning model again to acquire a set of first feature vectors, and then associating information indicating a position in the first feature map with each of the first feature vectors included in the set of first feature vectors.

11. The method according to claim 10, wherein
the step (a) includes:
(a2) a step of inputting the input data belonging to one of the classes to the machine learning model again to acquire the set of first feature vectors, and then associating information for identifying the input data with each of the first feature vectors included in the set of first feature vectors.

12. An information processing device for generating descriptive information regarding a class classification of a machine learning model for classifying classes of input data, wherein
the machine learning model
is a convolutional neural network including a plurality of residual blocks and including convolutional layers, and
is generated by machine learning using a training dataset including a set of pairs of a plurality of pieces of input data and a prior label associated with the input data, the prior label indicating a class to which the input data belongs among a plurality of classes, and
the information processing device executes:
(a) processing for inputting the input data belonging to one of the classes to the machine learning model again, and acquiring a set of M×N first feature vectors corresponding to a size of first feature maps and associated with one of the classes from L first feature maps that are outputs of a specific layer of the machine learning model, M and N being integers equal to or greater than 1, L being the number of channels, the first feature vector being obtained by vectorizing a feature amount included in L first feature maps along a channel direction;
(b) processing for executing the processing (a) using each of the plurality of pieces of input data belonging to one of the classes as an input;
(c) processing for executing the processing (b) for each of the plurality of classes to generate, for each class, a known feature vector group including a set of the first feature vectors associated with the classes;
(d) processing for receiving a designation of a range serving as a similarity calculation target in discrimination target data different from the input data, the discrimination target data being discrimination target data input to the machine learning model;
(e) processing for inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction;
(f) processing for associating information indicating a position in the second feature map that is an output of the specific layer with each of the second feature vectors included in the set of second feature vectors acquired in processing (e); and
(g) processing for calculating a similarity between the designated range in the discrimination target data and at least one of the classes using the set of second feature vectors acquired in the processing (e) and the known feature vector group of at least one of the classes.

13. The device according to claim 12, wherein
the machine learning model further has a structure in which a resolution of data is reduced to half or less by four or fewer convolutional layers.

14. A non-transitory computer-readable storage medium storing a program for causing a computer to execute processing for generating descriptive information regarding a class classification of a machine learning model for classifying classes of input data, wherein
the machine learning model
is a convolutional neural network including a plurality of residual blocks and including convolutional layers, and
is generated by machine learning using a training dataset including a set of pairs of a plurality of pieces of input data and a prior label associated with the input data, the prior label indicating a class to which the input data belongs among a plurality of classes, and
the program causes the computer to execute:
(a) processing for inputting the input data belonging to one of the classes to the machine learning model again, and acquiring a set of M×N first feature vectors corresponding to a size of first feature maps and associated with one of the classes from L first feature maps that are outputs of a specific layer of the machine learning model, M and N being integers equal to or greater than 1, L being the number of channels, the first feature vector being obtained by vectorizing a feature amount included in L first feature maps along a channel direction;
(b) processing for executing the processing (a) using each of the plurality of pieces of input data belonging to one of the classes as an input;
(c) processing for executing the processing (b) for each of the plurality of classes to generate, for each class, a known feature vector group including a set of the first feature vectors associated with the classes;
(d) processing for receiving a designation of a range serving as a similarity calculation target in discrimination target data different from the input data, the discrimination target data being discrimination target data input to the machine learning model;
(e) processing for inputting the discrimination target data to the machine learning model and acquiring a set of M×N second feature vectors corresponding to the size of the second feature map from a second feature map that is an output of the specific layer of the machine learning model, the second feature vectors being obtained by vectorizing L feature amounts included in the second feature map along the channel direction;
(f) processing for associating information indicating a position in the second feature map that is an output of the specific layer with each of the second feature vectors included in the set of second feature vectors acquired in processing (e); and
(g) processing for calculating a similarity between the designated range in the discrimination target data and at least one of the classes using the set of second feature vectors acquired in the processing (e) and the known feature vector group of at least one of the classes.

15. The non-transitory computer-readable storage medium storing a program according to claim 14, wherein
the machine learning model further has a structure in which a resolution of data is reduced to half or less by four or fewer convolutional layers.
